(19) United States
(12) Patent Application Publication
(10) Pub. No.: US 2017/0124386 A1
(43) Pub. Date: May 4, 2017

(54) METHOD, DEVICE AND COMPUTER-READABLE MEDIUM FOR REGION RECOGNITION

(71) Applicant: Xiaomi Inc., Beijing (CN)

(72) Inventors: Fei LONG, Beijing (CN); Tao ZHANG, Beijing (CN); Zhijun CHEN, Beijing (CN)

(73) Assignee: Xiaomi Inc.

(21) Appl. No.: 15/299,613

(22) Filed: Oct. 21, 2016

(30) Foreign Application Priority Data
Oct. 30, 2015 (CN) 201510728282.1

(51) Int. Cl. G06K 9/00; G06T 7/00

(52) U.S. Cl. CPC G06K 9/00288; G06K 9/00228; G06T 7/0081; G06T 2207/30201

(57) ABSTRACT

A method for a device to perform region recognition is provided. The method includes: obtaining a position of a face region in an identification image; determining at least one information region based on the position of the face region; and segmenting the information region to obtain at least one character region.

### CROSS-REFERENCE TO RELATED APPLICATION

This application and claims priority to Chinese Patent Application No. 201510728282.1, filed Oct. 30, 2015, which is incorporated herein by reference in its entirety.

### TECHNICAL FIELD

The present disclosure generally relates to the field of image processing and, more particularly, to a method, a device, and a computer-readable medium for region recognition.

### BACKGROUND

Automatic recognition of an identity card detects character information on the identity card by image processing.

The related technology provides a method for automatically recognizing an identity card, which includes scanning the identity card by an identity card scanning device in a fixed relative location to obtain the scanned image of the identity card, and recognizing the characters of predefined regions in the scanned image to obtain information about the name, gender, nationality, date of birth, address and civil identity number. However, it may be difficult to recognize the image of the identity card obtained by photographing.

### SUMMARY

According to a first aspect of the present disclosure, there is provided a method for a device to perform region recognition, comprising: obtaining a position of a face region in an identification image; determining at least one information region based on the position of the face region; and segmenting the information region to obtain at least one character region.

According to a second aspect of the present disclosure, there is provided a device for region recognition, comprising: a processor; and a memory for storing instructions executable by the processor. The processor is configured to: obtain a position of a face region in an identification image; determine at least one information region based on the position of the face region; and segment the information region to obtain at least one character region.

According to a third aspect of the present disclosure, there is provided a non-transitory computer-readable storage medium having stored therein instructions that, when executed by a processor of a device, causes the device to perform a method for region recognition, the method comprising: obtaining a position of a face region in an identification image; determining at least one information region based on the position of the face region; and segmenting the information region to obtain at least one character region.

It is to be understood that both the forgoing general description and the following detailed description are exemplary only, and are not restrictive of the present disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flowchart of a method for region recognition, according to an exemplary embodiment.

FIG. 2 is a flowchart of a method for region recognition, according to another exemplary embodiment.

FIG. 3A is a flowchart of a method for region recognition, according to another exemplary embodiment.

FIG. 3B is a schematic diagram illustrating face recognition, according to an exemplary embodiment.

FIG. 3C is a flowchart of a method for region recognition, according to an exemplary embodiment.

FIG. 3D is a schematic diagram illustrating a face image subjected to a Sobel horizontal filter, according to an exemplary embodiment.

FIG. 3E is a schematic diagram illustrating a binarized face image, according to an exemplary embodiment.

FIG. 3F is a schematic diagram illustrating a Hough transformation, according to an exemplary embodiment.

FIG. 4 is a flowchart of a method for region recognition, according to another exemplary embodiment.

FIG. 5A is a flowchart of a method for region recognition, according to another exemplary embodiment.

FIG. 5B is a schematic diagram illustrating a first histogram of the information region, according to an exemplary embodiment.

FIG. 5C is a schematic diagram illustrating a set of consecutive rows of the information region, according to an exemplary embodiment.

FIG. 5D is a schematic diagram illustrating a histogram of the information region, according to an exemplary embodiment.

FIG. 5E is a schematic diagram illustrating a set of consecutive columns of the information region, according to an exemplary embodiment.

FIG. 6 is a block diagram of a device for region recognition, according to an exemplary embodiment.

FIG. 7 is a block diagram of a device for region recognition, according to another exemplary embodiment.

FIG. 8 is a block diagram of a detection sub-module in the device for region recognition, according to an exemplary embodiment.

FIG. 9 is a block diagram of a device for region recognition, according to another exemplary embodiment.

FIG. 10 is a block diagram of a device for region recognition, according to another exemplary embodiment.

FIG. 11 is a block diagram of a device for region recognition, according to an exemplary embodiment.

### DETAILED DESCRIPTION

Reference will now be made in detail to exemplary embodiments, examples of which are illustrated in the accompanying drawings. The following description refers to the accompanying drawings in which same numbers in different drawings represent same or similar elements unless otherwise described. The implementations set forth in the following description of exemplary embodiments do not represent all implementations consistent with the disclosure. Instead, they are merely examples of devices and methods consistent with aspects related to the disclosure as recited in the appended claims.

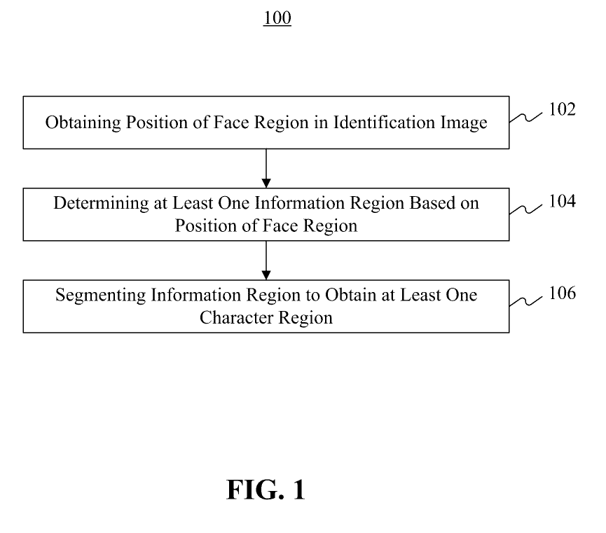

FIG. 1 is a flowchart illustrating a method 100 for region recognition, according to an exemplary embodiment. The method 100 may be performed by a device such as a mobile phone, a computer, a digital broadcast terminal, a messaging device, a gaming console, a tablet, a medical device, exercise equipment, a personal digital assistant, and the like. Referring to FIG. 1, the method 100 may include the following steps.

In step 102, the device obtains a position of a face region in an identification image. The identification image may be obtained by photographing an identification, such as an identity card, a social security card and the like. Since the identification usually contains a photo of the user, the identification image may include a face region.

In step 104, the device determines at least one information region based on the position of the face region.

Since the location of the face region in the identification is relatively fixed, the information region in the identification image may be detected based on the position of the face region.

In the present disclosure, the information region refers to the region in the identification image that contains character information, such as name, date of birth, gender, address, civil identity number, serial number, issuance office, expiration date and the like.

In step 106, the device performs segmentation on the information region to obtain at least one character region.

The information region may include a plurality of characters. The character region may be obtained by segmenting the information region. The character region is a region containing a single character, where the character may be a Chinese character, an English letter, a numeral, or a character of other language.

In the method 100, the information region and character region are determined based on the position of the face region in the identification image. In doing so, the information region and character region may be detected accurately.

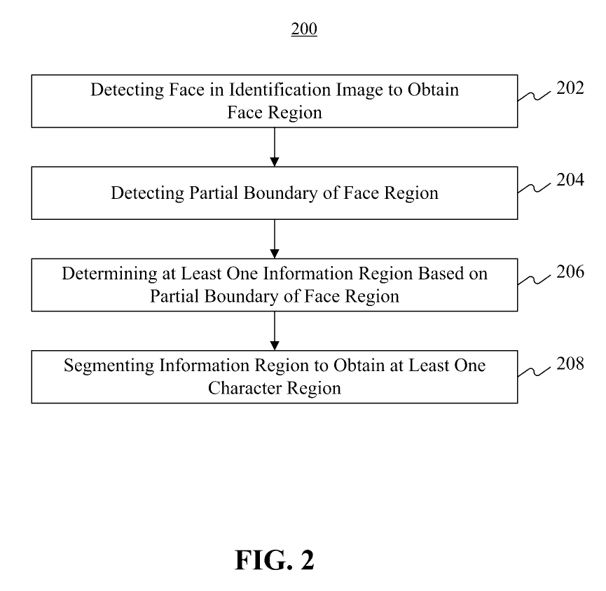

FIG. 2 is a flowchart illustrating a method 200 for region recognition, according to another exemplary embodiment. The method 200 may be performed by a device such as a mobile phone, a computer, a digital broadcast terminal, a messaging device, a gaming console, a tablet, a medical device, exercise equipment, a personal digital assistant, and the like. Referring to FIG. 2, the method 200 may include the following steps.

In step 202, the device detects a face in an identification image to obtain a face region.

For example, when photographing the identification, a rectangular region in a photographing interface may be displayed for facilitating the photographing, and a user may obtain an image of the identification by aligning the rectangular region to the identification.

Since the identification usually contains a photo of the user, the identification image may include a face region. The face region in the identification image may be detected using face recognition technology. The present disclosure does not intend to limit the type of face recognition technology that can be used.

In step 204, the device detects a partial boundary of the face region based on the face region.

For example, the partial boundary may be a predefined lower boundary of the face region. The lower boundary of the face region may form a contrast to the background color of the identification, thereby facilitating its detection.

In step 206, the device determines at least one information region based on the partial boundary of the face region.

When the type of the identification image is known, the relative position between the partial boundary of the face region and the information region of the identification may be fixed, and the information region may be determined based on the relative position to the partial boundary of the face region.

For example, in the Chinese second-generation identity card, the civil identity number is located below the lower boundary of the face region. As another example, the address information is located to the left of the face region in the horizontal direction and is located between the lower boundary of the face region and the middle of the face region in the vertical direction. boundary

In step 208, the device performs segmentation on the information region to obtain at least one character region. The information region may include a plurality of characters. The character region may be obtained by segmenting the information region. The character region is a region containing a single character, where the character may be a Chinese character, an English letter, a numeral, or a character of other language.

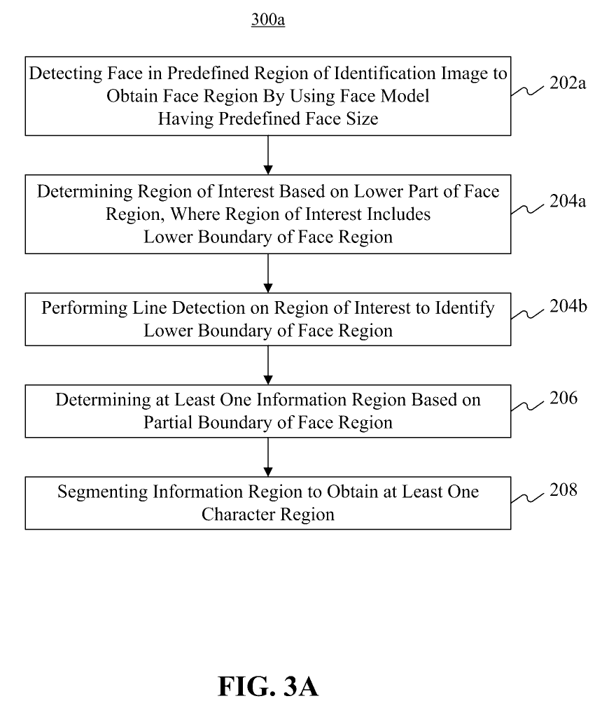

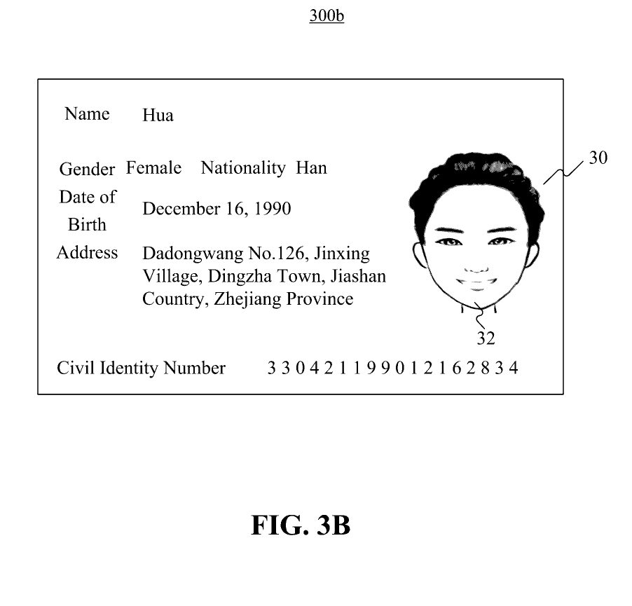

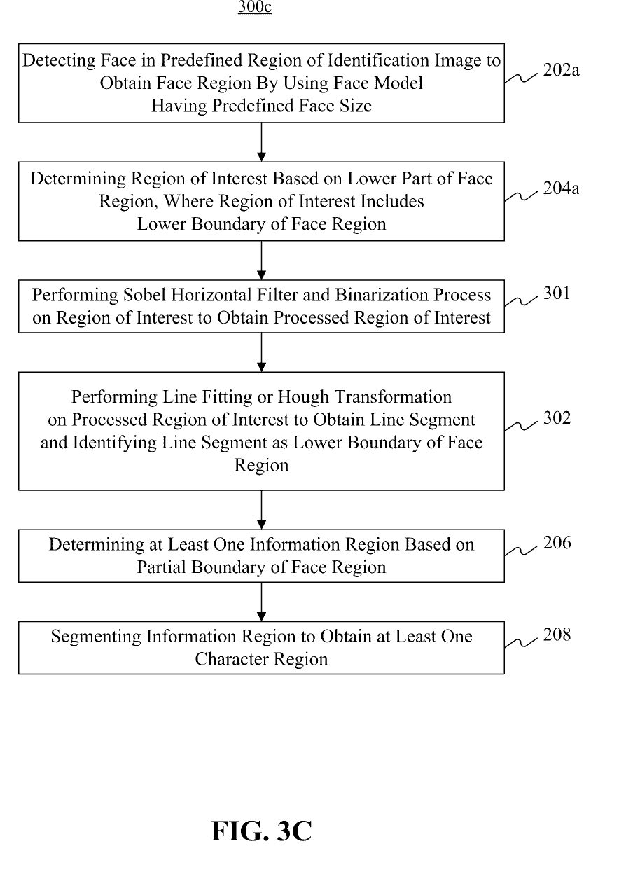

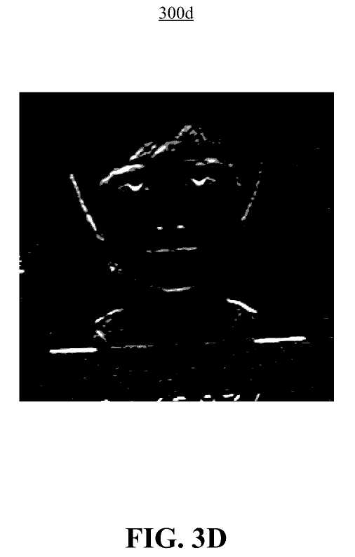

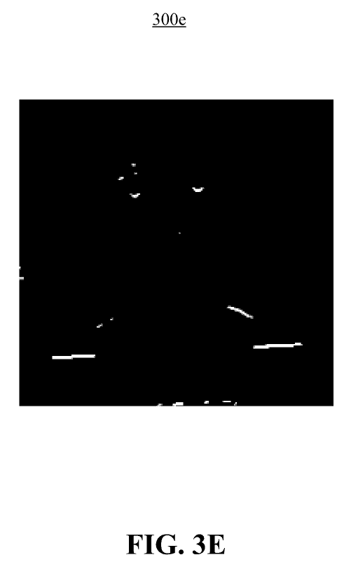

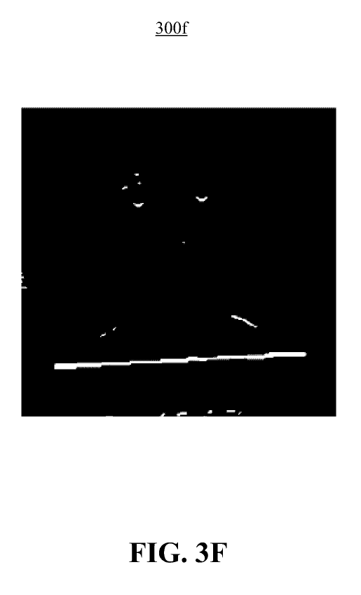

FIG. 3A is a flowchart of a method 300a for region recognition, according to another exemplary embodiment. As shown in FIG. 3A, the above step 202 may be implemented as step 202a, and the above step 204 may be implemented as steps 204a and 204b. The method 300a includes steps 206 and 208 discussed above in connection with FIG. 2, and the description of which will not be repeated.

In step 202a, the device detects a face in a predefined region of the identification image to obtain the face region by using a face model having a predefined face size.

For example, a pre-training process may be performed to obtain a face model. Since the size of the face region in the identification image is relatively fixed, the face model may be set to have a predefined face size.

For example, the device may detect a face in the predefined region of the identification image to obtain the face region by using the face model. In some embodiments, the identification image may be segmented into a plurality of grid regions, and the image characteristic of each grid region may be extracted and inputted into the face model. When the face model outputs a positive result, the corresponding grid region is identified as a face region, and when the face model outputs a negative result, the corresponding window region is identified as a non-face region.

In some embodiments, since the face region is usually located at upper right of the identification, face recognition may be first performed on the right predefined region of the identification image.

In step 204a, the device determines a region of interest based on the lower part of the face region, where the region of interest includes a lower boundary of the face region.

For example, the region of interest may be determined at the lower part of the face region based on a preset window to cover the lower boundary of the face region.

FIG. 3B is a schematic diagram 300b illustrating face recognition, according to an exemplary embodiment. As shown in FIG. 3B, after detecting the face region 30, the region of interest may be selected from the identification image by taking the center 32 of the lower part of the face region 30 as a center and setting the size of the region as the size of the preset window.

In step 204b, the device performs a line detection on the region of interest to identify the lower boundary of the face region. For example, the line detection method may use a line fitting algorithm or a Hough transformation algorithm.

FIG. 3C is a flowchart of a method 300c for region recognition, according to an exemplary embodiment. As shown FIG. 3C, the step 204b may be implemented as step 301 and step 302. The method 300c includes steps 202a, 204a, 206, and 208 discussed above in connection with FIG. 3A.

In step 301, the device performs a Sobel horizontal filter and a binarization process on the region of interest to obtain a processed region of interest.

The region of interest is filtered with a Sobel operator in the horizontal direction. FIG. 3D is a schematic diagram 300d illustrating a face image subjected to a Sobel horizontal filter, according to an exemplary embodiment. Then, the filtered region of interest is binarized, where the gray values of the pixel points in the region of interest are compared with a predefined threshold. The pixel points in the region of interest are divided into two groups: a first group of pixel points whose gray values are greater than the predefined gray threshold and a second group of pixel points whose gray values are lower than the predefined gray threshold. The two groups of pixel points are presented with colors of black and white in the identification image, thereby obtaining the binarized region of interest. FIG. 3E is a schematic diagram 300e illustrating a binarized face image, according to an exemplary embodiment. As shown in FIG. 3E, the white pixel points are referred to as the pixel points of foreground color, and the black pixel points are referred to as the pixel points of background color.

In step 302, the device performs the line fitting or Hough transformation on the processed region of interest to obtain a line segment as the lower boundary on the face region, where the length of the line segment is greater than a predefined length.

FIG. 3F is a schematic diagram 300f illustrating a Hough transformation, according to an exemplary embodiment. As shown in FIG. 3F, after performing Hough transformation, a line segment located in the lower part of the face region is obtained as the lower boundary of the face region.

Since the region of interest is a relatively small region, the method 300c requires relatively light computation to extract the lower boundary, thereby improving the recognition speed.

Referring to FIG. 3C, in step 202a, a training process may be performed to obtain the face model. For example, the training process may include the following steps.

A positive sample image and a negative sample image may be pre-acquired. The positive sample image may include a face region having a predefined size. The negative sample image may include an image having no face region, an image containing incomplete face region, an image having a face region different from the predefined size, an image with noisy background, and so on.

Image characteristics of the positive sample image and image characteristics of the negative sample image, such as haar characteristic, are extracted. Then, the image characteristic of the positive sample image and a first descriptor representing the positive result are inputted into an initial model, the image characteristic of the negative sample image and a second descriptor representing the negative result are inputted into the initial model, and a face model is obtained after training. For example, the first descriptor may be set as “1”, and the second descriptor may be set as “0”. The initial model is constructed through sorting algorithm, such as Adaboost or Support Vector Machine (SVM).

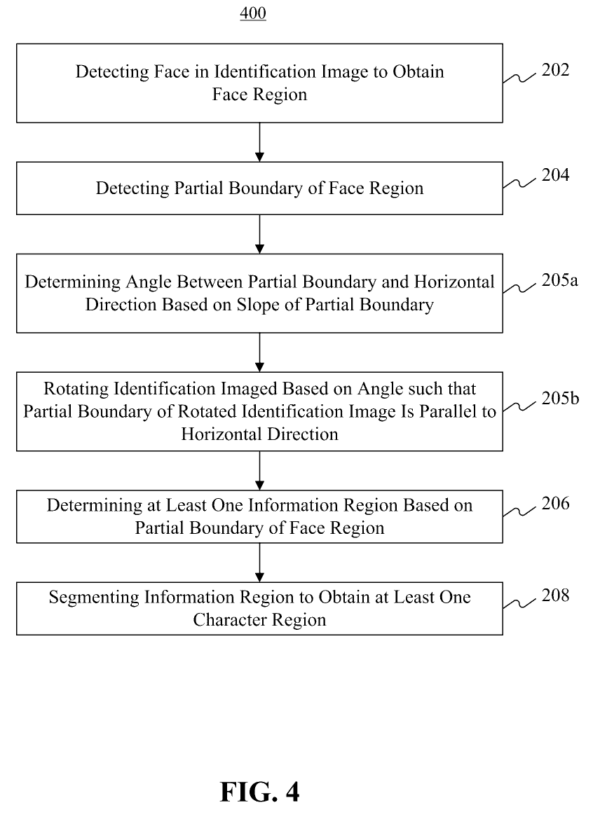

FIG. 4 is a flowchart of a method 400 for region recognition, according to another exemplary embodiment. Referring to FIG. 4, the method 400 further includes steps 205a and 205b after the step 204 described above in connection with FIG. 2. In the method 400, the identification may have been rotated for an angle with respect to the horizontal direction in the identification image, and the device may correct tilt of the identification image based on the slope of the partial boundary.

In step 205a, the device determines an angle between the partial boundary and the horizontal direction based on the slope of the boundary.

For example, the device may calculate an angle between the lower boundary of the face region and the horizontal direction, which corresponds to the angle between the identification and the horizontal direction.

In step 205b, the device rotates the identification image based on the angle, such that the partial boundary of the rotated identification image is parallel to the horizontal direction. In doing so, the method 400 corrects the tilt of the identification image such that the identification is parallel to the horizontal direction, thereby improving the accuracy of the subsequent information region detection.

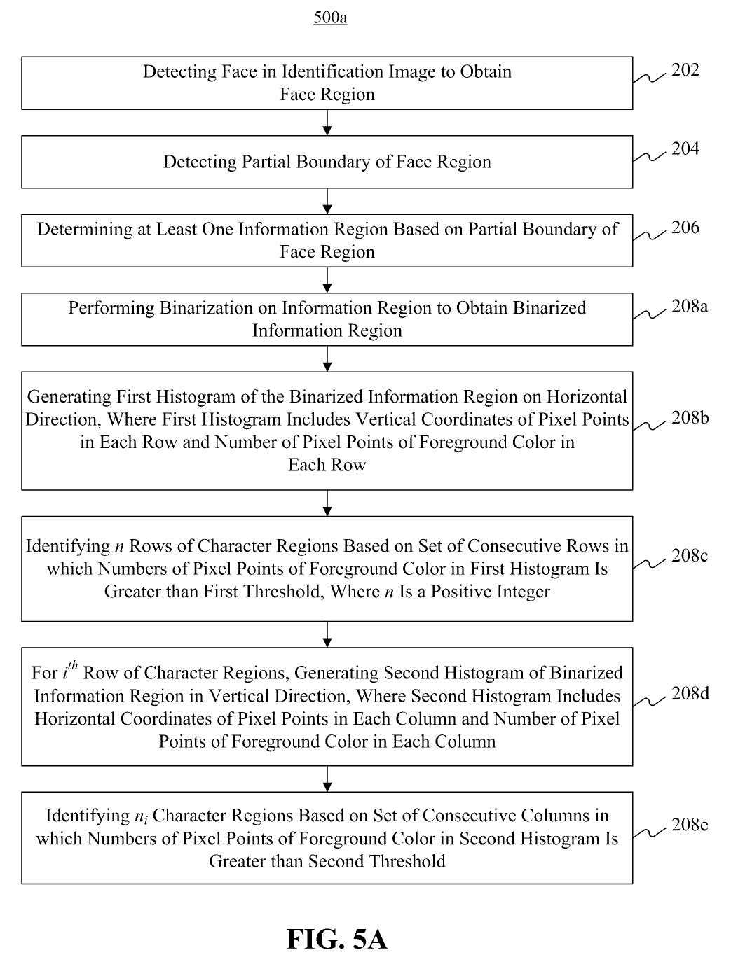

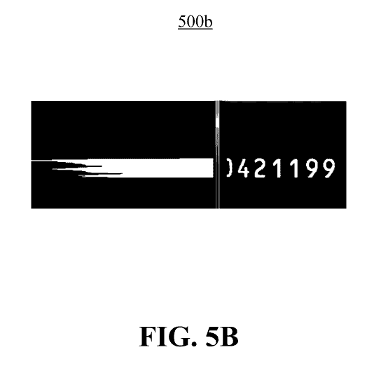

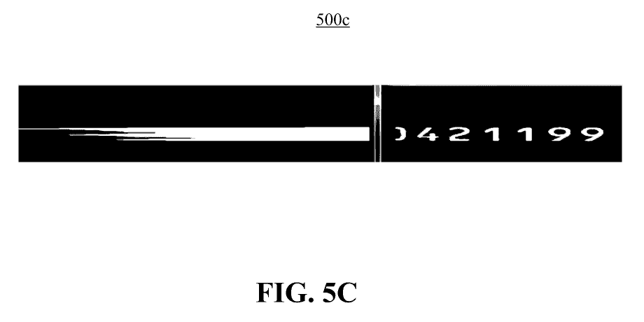

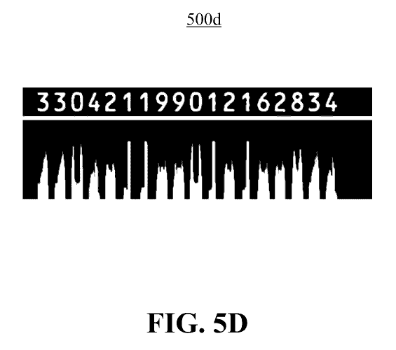

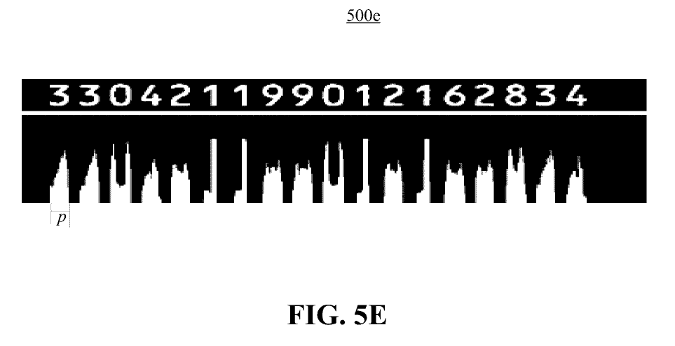

FIG. 5A is a flowchart of a method 500a for region recognition, according to another exemplary embodiment. Referring to FIG. 5A, the method 500a includes steps 202, 204, and 206 discussed above in connection with FIG. 2. In the method 500a, the step 208 of segmenting the information region may be implemented as the following steps 208a-208e, as shown in FIG. 5A.

In step 208a, the device performs binarization on the information region to obtain a binarized information region.

For example, the information region may be firstly pre-processed, and the pre-processing may include operations such as de-noising, filtering, extracting boundaries and so on. The pre-processed information region may then be binarized.

In step 208b, the device generates a first histogram of the binarized information region in the horizontal direction, where the first histogram includes the vertical coordinates of the pixel points in each row and the number of the pixel points of the foreground color in each row.

FIG. 5B is a schematic diagram 500b illustrating a histogram of the information region, according to an exemplary embodiment.

In step 208c, the device identifies n rows of character regions based on the set of consecutive rows in which the numbers of the pixel points of the foreground color in the first histogram are greater than a first threshold, wherein n is a positive integer.

The numbers of the pixel points of the foreground color in each row can be obtained based on the first histogram. The device may compare the numbers of the pixel points of the foreground color in each row with the first threshold, and the character regions may be determined to be located in the set of m consecutive rows in which the numbers of the pixel points of the foreground color in the first histogram are greater than the first threshold.

FIG. 5C is a schematic diagram 500c illustrating a set of consecutive rows of the information region, according to an exemplary embodiment. As shown in FIG. 5C, the m consecutive rows of pixel points correspond to the row of civil identity number “0421299” in the identification image.

When the information region is the address information region or other information regions, the character region may contain two or more rows. In this circumstance, each set of consecutive rows may be identified as a row of character regions, and n sets of consecutive rows may be identified as n rows of character regions.

In step 208d, the device generates a second histogram in the vertical direction for an i^{th} row of character regions, where the second histogram includes the horizontal coordinate of the pixel points in each column and the number of the pixel points of the foreground color in each column, where n≧i≧1 and i is a positive integer. FIG. 5D is a schematic diagram 500d illustrating a second histogram of the information region, according to an exemplary embodiment.

In step 208e, the device identifies nᵢ character regions based on the set of consecutive columns in which the numbers of the pixel points of the foreground color in the second histogram is greater than a second threshold.

The numbers of the pixel points of the foreground color in the pixel points in each column can be obtained based on the second histogram. The device may compare the numbers of the pixel points of the foreground color in each column with the second threshold, and the character regions may be determined to be located in the set of p consecutive columns in which the numbers of the pixel points of the foreground color in the second histogram are greater than the second threshold.

FIG. 5E is a schematic diagram illustrating the set of consecutive columns of the information region, according to an exemplary embodiment. As shown in FIG. 5E, the set of consecutive columns is represented by “p”, i.e., the consecutive white region formed in the second histogram. For the p consecutive columns of pixel points in FIG. 5E, the numbers of the pixel points of the foreground color in the second histogram are greater than the second threshold. The p consecutive columns of pixel points correspond to the character region “3” in the identification image.

Each set of consecutive columns is identified as one character region, and n sets of consecutive columns are identified as n character regions. In the example of FIG. 5E, 18 character regions are identified.

When there are n rows of character regions, the steps 208d and 208e may be performed for each of the n rows of character regions.

For each identified character region, the character contained in the character region may be identified by using character identification technology. The characters may be Chinese characters, English letters, numbers, and characters of other language.

By binarizing the information region, generating a first histogram of the binarized information region in the horizontal direction, and generating a second histogram of the n rows of character regions in the vertical direction, the accuracy of detecting the character regions in the information region may be improved.

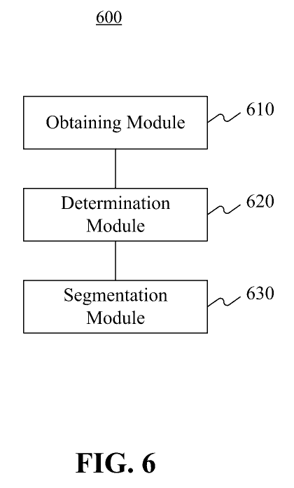

FIG. 6 is a block diagram of a device 600 for region recognition, according to an exemplary embodiment. Referring to FIG. 6, the device 600 may include an obtaining module 610, a determination module 620, and a segmentation module 630.

The obtaining module 610 is configured to obtain a position of a face region in an identification image. The identification image may be obtained by photographing an identification, such as an identity card, a social security card and the like. Since the identification usually contains a photo of the user, the identification image may include a face region. The obtaining module 610 obtains the position of the face region in the identification image.

The determination module 620 is configured to determine at least one information region based on the position of the face region obtained by the obtaining module 610. The information region refers to the region in the identification image that contains character information such as name, date of birth, gender, address, civil identity number, serial number, issuance office, expiration date and the like.

The segmentation module 630 is configured to perform segmentation on the information region to obtain at least one character region.

The information region may include a plurality of characters. The character region can be obtained by segmenting one information region. The character region is a region containing a single character, where the character may be Chinese character, English letter, numeral or a character of other language.

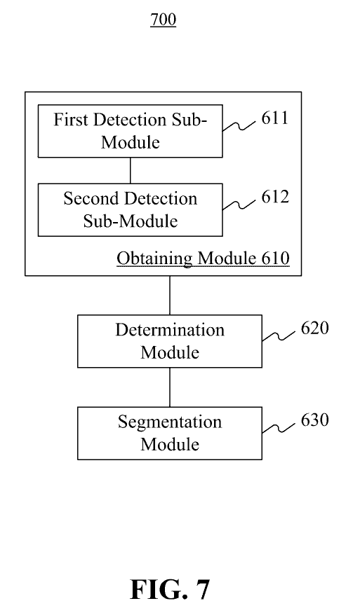

FIG. 7 is a block diagram of a device 700 for region recognition, according to another exemplary embodiment. Referring to FIG. 7, the device 700 may include the obtaining module 610, the determination module 620 and the segmentation module 630.

The obtaining module 610 may include a first detection sub-module 611 and a second detection sub-module 612.

The first detection sub-module 611 is configured to detect a face in the identification image to obtain the face region. The face region may be detected in the identification image by using face recognition technology.

The second detection sub-module 612 is configured to detect a partial boundary of the face region based on the face region.

The first detection sub-module 611 may be further configured to detect a face in a predefined region of the identification image to obtain the face region by using a face model having a predefined face size.

The determination module 620 may be configured to determine at least one information region based on the partial boundary of the face region and the relative position between the partial boundary of the face region and the information region of the identification.

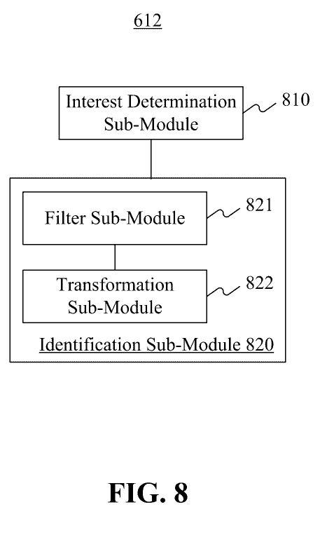

FIG. 8 is a block diagram of the second detection sub-module 612, according to an exemplary embodiment. Referring to FIG. 8, the second identification sub-module 612 may include an interest determination sub-module 810 and an identification sub-module 820.

The interest determination sub-module 810 is configured to determine a region of interest based on the lower part of the face region, where the region of interest includes lower boundary of the face region. The interest determination sub-module 810 determines the region of interest at the lower part of the face region based on a preset window so that the region of interest covers the lower boundary of the face region.

The identification sub-module 820 is configured to perform a line detection on the region of interest to identify the lower boundary of the face region.

For example, the line detection method may use a line fitting algorithm or a Hough transformation algorithm.

The identification sub-module 820 may include a filter sub-module 821 and a transformation sub-module 822.

The filter sub-module 821 is configured to perform Sobel horizontal filter and binarization on the region of interest to obtain a processed region of interest. The filter sub-module 821 may be configured to filter the region of interest with a Sobel operator on a horizontal direction, and then binarize the filtered region of interest.

For example, the filter sub-module 821 may be configured to compare the gray values of the pixel points in the region of interest with a predefined threshold, and divide the pixel points in the region of interest into two groups. The first group includes pixel points whose gray values are greater than the predefined threshold, and the second group includes pixel points whose gray values are lower than the predefined threshold. The two groups of pixel points are presented with colors of black and white in the identification image, thereby obtaining the binarized region of interest.

The transformation sub-module 822 is configured to perform the line fitting or Hough transformation on the processed region of interest to obtain a line segment as the lower boundary of the face region. The length of the line segment is greater than a predefined length.

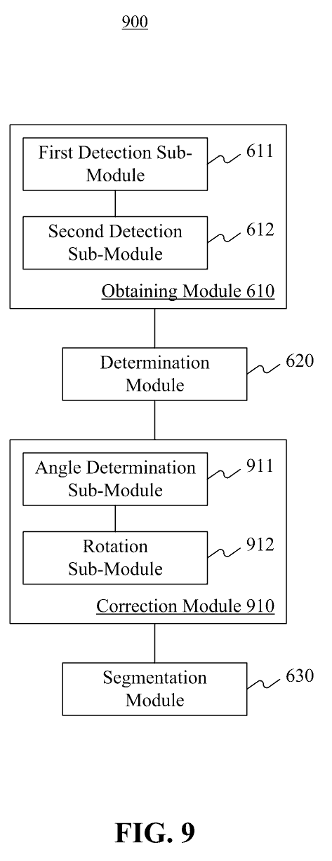

FIG. 9 is a block diagram of a device 900 for region recognition, according to another exemplary embodiment. Referring to FIG. 9, in addition to the obtaining module 610, the determination module 620, and the segmentation module 630, the device 900 may further include a correction module 910 configured to correct the tilt of the identification image based on the slope of the partial boundary.

The correction module 910 may include an angle determination sub-module 911 and a rotation sub-module 912.

The angle determination sub-module 911 is configured to determine an angle between the partial boundary and a horizontal direction based on the slope of the partial boundary. The angle determination sub-module 911 may be configured to calculate an angle between the lower boundary of the face region and the horizontal direction, which corresponds to the angle between the identification and the horizontal direction.

The rotation sub-module 912 is configured to rotate the identification image based on the angle calculated by the angle determination sub-module 911, such that the partial boundary of the rotated identification image is parallel to the horizontal direction after rotation.

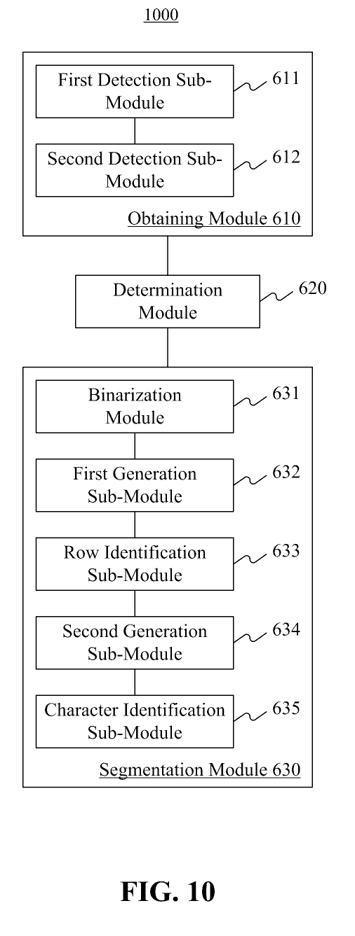

FIG. 10 is a block diagram of a device 1000 for region recognition, according to another exemplary embodiment. Referring to FIG. 10, the segmentation module 630 may include a binarization module 631, a first generation sub-module 632, a row identification sub-module 633, a second generation sub-module 634 and a character identification sub-module 635.

The binarization module 631 is configured to perform binarization on the information region to obtain a binarized information region. For example, the binarization module 631 may be configured to pre-process the information region, wherein the pre-processing may include operations such as de-noising, filtering, extracting boundaries and so on, and then binarize the pre-processed information region. The pre-processed information region may then be binarized.

The first generation sub-module 632 is configured to generate a first histogram of the binarized information region in the horizontal direction, where the first histogram includes vertical coordinates of the pixel points in each row and the number of the pixel points of the foreground color in each row.

The row identification sub-module 633 is configured to identify n rows of character regions based on the set of consecutive rows in which the numbers of the pixel points of the foreground color in the first histogram is greater than a first threshold, wherein n is a positive integer. The numbers of the pixel points of the foreground color in each row can be obtained based on the first histogram. The row identification sub-module 633 may be configured to compare the numbers of the pixel points of the foreground color in each row with the first threshold, and determine the character regions to be located in the set of m consecutive rows in which the numbers of the pixel points of the foreground color in the first histogram are greater than the first threshold.

Each set of consecutive rows is identified as a row of character regions, and n sets of consecutive rows are identified as n rows of character regions.

The second generation sub-module 634 is configured to, for the i^{th} row of character regions, generate a second histogram of the binarized information region in the vertical direction, where the second histogram includes the horizontal coordinates of the pixel points in each column and the numbers of the pixel points of the foreground color in each column, wherein n≧i≧1 and i is a positive integer.

The character identification sub-module 635 is configured to identify nᵢ character regions based on the set of consecutive columns in which the numbers of the pixel points of the foreground color in the second histogram are greater than a second threshold.

The numbers of the pixel points of the foreground color in each column can be obtained based on the second histogram. The character identification sub-module 635 may be configured to compare the numbers of the pixel points of the foreground color in each column with the second threshold, and determine the character regions to be located in the set of p consecutive columns in which the a numbers of the pixel points of the foreground color in the second histogram are greater than the second threshold.

Each set of consecutive columns is identified as one character region and n sets of consecutive columns are identified as n character regions.

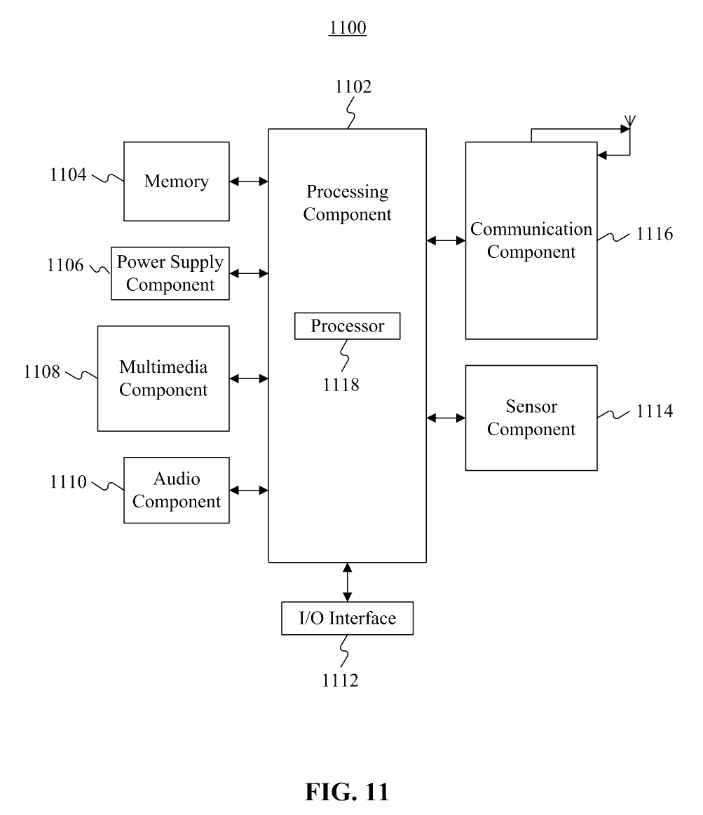

FIG. 11 is a block diagram of a device 1100 for region recognition, according to an exemplary embodiment. For example, the device 1100 may be a mobile phone, a computer, a digital broadcast terminal, a messaging device, a gaming console, a tablet, a medical device, exercise equipment, a personal digital assistant, and the like.

Referring to FIG. 11, the device 1100 may include one or more of the following components: a processing component 1102, a memory 1104, a power supply component 1106, a multimedia component 1108, an audio component 1110, an input/output (I/O) interface 1112, a sensor component 1114 and a communication component 1116. The person skilled in the art should appreciate that the structure of the device 1100 as shown in FIG. 11 does not intend to limit the device 1100. The device 1100 may include more or less components or combine some components or other different components.

The processing component 1102 typically controls overall operations of the device 1100, such as the operations associated with display, telephone calls, data communications, camera operations, and recording operations. The processing component 1102 may include one or more processors 1118 to execute instructions to perform all or part of the steps in the above described methods. Moreover, the processing component 1102 may include one or more modules which facilitate the interaction between the processing component 1102 and other components. For instance, the processing component 1102 may include a multimedia module to facilitate the interaction between the multimedia component 1108 and the processing component 1102.

The memory 1104 is configured to store various types of data to support the operation of the device 1100. Examples of such data include instructions for any applications or methods operated on the device 1100, contact data, phonebook data, messages, images, video, etc. The memory 1104 is also configured to store programs and modules. The processing component 1102 performs various functions and data processing by operating programs and modules stored in the memory 1104. The memory 1104 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power supply component 1106 is configured to provide power to various components of the device 1100. The power supply component 1106 may include a power management system, one or more power sources, and any other components associated with the generation, management, and distribution of power for the device 1100.

The multimedia component 1108 includes a screen providing an output interface between the device 1100 and a user. In some embodiments, the screen may include a liquid crystal display (LCD) and/or a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1108 includes a front camera and/or a rear camera. The front camera and the rear camera may receive an external multimedia datum while the device 1100 is in an operation mode, such as a photographing mode or a video mode. Each of the front camera and the rear camera may be a fixed optical lens system or have optical focusing and zooming capability.

The audio component 1110 is configured to output and/or input audio signals. For example, the audio component 1110 includes a microphone configured to receive an external audio signal when the device 1100 is in an operation mode, such as a call mode, a recording mode, and a voice recognition mode. The received audio signal may be further stored in the memory 1104 or transmitted via the communication component 1116. In some embodiments, the audio component 1110 further includes a speaker to output audio signals.

The I/O interface 1112 provides an interface between the processing component 1102 and peripheral interface modules, the peripheral interface modules being, for example, a keyboard, a click wheel, buttons, and the like. The buttons may include, but are not limited to, a home button, a volume button, a starting button, and a locking button.

The sensor component 1114 includes one or more sensors to provide status assessments of various aspects of the device 1100. For instance, the sensor component 1114 may detect an on/off state of the device 1100, relative positioning of components (e.g., the display and the keypad, of the device 1100), a change in position of the device 1100 or a component of the device 1100, a presence or absence of user contact with the device 1100, an orientation or an acceleration/deceleration of the device 1100, and a change in temperature of the device 1100. The sensor component 1114 may include a proximity sensor configured to detect the presence of a nearby object without any physical contact. The sensor component 1114 may also include a light sensor, such as a CMOS or CCD image sensor, for use in imaging applications. In some embodiments, the sensor component 1114 may also include an accelerometer sensor, a gyroscope sensor, a magnetic sensor, a pressure sensor, or a temperature sensor.

The communication component 1116 is configured to facilitate communication, wired or wirelessly, between the device 1100 and other devices. The device 1100 can access a wireless network based on a communication standard, such as WiFi, 2G or 3G or a combination thereof. In an exemplary embodiment, the communication component 1116 receives a broadcast signal or broadcast information from an external broadcast management system via a broadcast channel. In an exemplary embodiment, the communication component 1116 further includes a near field communication (NFC) module to facilitate short-range communications. For example, the NFC module may be implemented based on a radio frequency identification (RFID) technology, an infrared data association (IRDA) technology, an ultra-wideband (UWB) technology, a Bluetooth (BT) technology, and other technologies.

In exemplary embodiments, the device 1100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1104, executable by the processor 1118 in the device 1100, for performing the above-described methods. For example, the non-transitory computer-readable storage medium may be a ROM, a RAM, a CD-ROM, a magnetic tape, a floppy disc, an optical data storage device, and the like.

It should be understood by those skilled in the art that the above described modules can each be implemented through hardware, or software, or a combination of hardware and software. One of ordinary skill in the art will also understand that multiple ones of the above described modules may be combined as one module, and each of the above described modules may be further divided into a plurality of sub-modules.

Other embodiments of the disclosure will be apparent to those skilled in the art from consideration of the specification and practice of the disclosures herein. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the inventive concept is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for a device to perform region recognition, comprising:
obtaining a position of a face region in an identification image;
determining at least one information region based on the position of the face region; and
segmenting the information region to obtain at least one character region.

2. The method of claim 1, wherein obtaining a position of a face region in an identification image comprises:
detecting a face in the identification image to obtain the face region; and
detecting a partial boundary of the face region based on the face region.

3. The method of claim 2, wherein detecting a face in the identification image comprises:
detecting a face in a predefined region of the identification image based on a face model having a predefined face size.

4. The method of claim 2, wherein detecting a partial boundary of the face region based on the face region comprises:
determining a region of interest based on a lower part of the face region, wherein the region of interest includes a lower boundary of the face region; and
performing a line detection on the region of interest to detect the lower boundary of the face region.

5. The method of claim 4, wherein said performing a line detection on the region of interest comprises:
performing a Sobel horizontal filter and a binarization process on the region of interest to obtain a processed region of interest; and
performing a line fitting or a Hough transformation on the processed region of interest to obtain a line segment and identifying the line segment as the lower boundary of the face region, wherein a length of the line segment is greater than a predefined length.

6. The method of claim 2, further comprising:
correcting a tilt of the identification image based on a slope of the partial boundary.

7. The method of claim 6, wherein correcting a tilt of the identification image comprises:
determining an angle between the partial boundary and a horizontal direction based on the slope of the partial boundary; and
rotating the identification image based on the angle.

8. The method of claim 1, wherein segmenting the information region comprises:
binarizing the information region;
generating a first histogram for the binarized information region in a horizontal direction, wherein the first histogram includes vertical coordinates of pixel points in each row and a number of pixel points of a foreground color in each row;
identifying n rows of character regions based on a set of consecutive rows, wherein the number of the pixel points of the foreground color in each of the consecutive rows is greater than a first threshold, and n is a positive integer;
for an i^{th} row of the character regions, generating a second histogram in a vertical direction, wherein the second histogram includes horizontal coordinates of pixel points in each column and a number of pixel points of the foreground color in each column, wherein n≧i≧1 and i is a positive integer; and
identifying one or more character regions based on a set of consecutive columns, wherein the number of the pixel points of the foreground color in each of the consecutive columns is greater than a second threshold.

9. A device for region recognition, comprising:
a processor;
a memory for storing instructions executable by the processor;
wherein the processor is configured to:
obtain a position of a face region in an identification image;
determine at least one information region based on the position of the face region; and
segment the information region to obtain at least one character region.

10. The device of claim 9, wherein the processor is further configured to:
detect a face in the identification image to obtain the face region; and
detect a partial boundary of the face region based on the face region.

11. The device of claim 10, wherein the processor is further configured to detect a face in a predefined region of the identification image based on a face model having a predefined face size.

12. The device of claim 10, wherein the processor is further configured to:
determine a region of interest based on a lower part of the face region, wherein the region of interest includes a lower boundary of the face region; and
perform a line detection on the region of interest to detect the lower boundary of the face region.

13. The device of claim 12, wherein the processor is further configured to:
perform a Sobel horizontal filter and a binarization process on the region of interest to obtain a processed region of interest; and
perform a line fitting or a Hough transformation on the processed region of interest to obtain a line segment and identify the line segment as the lower boundary on the face region, wherein a length of the line segment is greater than a predefined length.

14. The device of claim 10, wherein the processor is further configured to:
correct a tilt of the identification image based on a slope of the partial boundary.

15. The device of claim 14, wherein the processor is further configured to:
determine an angle between the partial boundary and a horizontal direction based on the slope of the partial boundary; and
rotate the identification image based on the angle.

16. The device of claim 9, wherein the processor is further configured to:
binarize the information region;
generate a first histogram for the binarized information region in a horizontal direction, wherein the first histogram includes vertical coordinates of pixel points in each row and a number of pixel points of a foreground color in each row;
identify n rows of character regions based on a set of consecutive rows, wherein the number of the pixel points of the foreground color in each of the consecutive rows is greater than a first threshold, and n is a positive integer;
for an i^{th} row of the character regions, generate a second histogram in a vertical direction, wherein the second histogram includes horizontal coordinates of pixel points in each column and a number of pixel points of the foreground color in each column, wherein n≧i≧1 and i is a positive integer; and
identify one or more character regions based on a set of consecutive columns, wherein the number of the pixel points of the foreground color in each of the consecutive columns is greater than a second threshold.

17. A non-transitory computer-readable storage medium having stored therein instructions that, when executed by a processor of a device, cause the device to perform a method for region recognition, the method comprising:
obtaining a position of a face region in an identification image;
determining at least one information region based on the position of the face region; and
segmenting the information region to obtain at least one character region.
